(19) United States
(12) Patent Application Publication
(10) Pub. No.: US 2016/0063543 A1
(43) Pub. Date: Mar. 3, 2016

(54) METHOD AND SYSTEM FOR PROVIDING A MANAGED BRANDED MARKETPLACE

(71) Applicant: S. Michael Kernan, Beverly Hills, CA (US)

(72) Inventor: S. Michael Kernan, Beverly Hills, CA (US)

(21) Appl. No.: 14/470,539

(22) Filed: Aug. 27, 2014

(51) Int. Cl. G06Q 30/02

(52) U.S. Cl. CPC G06Q 30/0253

(57) ABSTRACT

The present disclosure provides methods and systems for managing an online marketplace platform for branded marketing content. The methods and systems include a receiving module configured to receive one or more of branded marketing content by a plurality of branded marketing content providers, a displaying module configured to display one or more of branded marketing content by a respective set of the plurality of branded marketing content providers, and a contracting module to enable contracting a deal between the first of one or more of branded content providers with the advertiser. The displaying module enables selection of the set of one or more of branded marketing content to present to the advertiser. The advertiser and the one or more of branded content providers strikes a deal on meeting of pre-defined conditions. The advertiser may request based on a predefined criteria and a pre-defined one or more formats.

### TECHNICAL FIELD

The present disclosure generally relates to online marketplace platform, and more particularly, relates to methods and systems for managing the online marketplace platform for branded marketing content.

### BACKGROUND

In this Internet era, the popularity of playing streaming video over online video content hosting providers such as YouTube, Netflix, Amazon, and Hulu are increasing by leaps and bounds. These online video content hosting providers provides user unlimited viewing of the content for enjoyment and knowledge purposes.

Generally, the online video content hosting providers insert advertisements of advertisers in the streaming videos after fixed intervals and earn revenue from it. More often than not, they share the generated revenue with the content providers. For example, a company X creates an interesting video and host the same video on a platform Y. The system associated with the platform Y may insert advertisement of an advertiser Z in the interesting video. The advertiser Z may pay the platform Y according to the number of the users who viewed the interesting video. The platform Y may share the revenue generated by the interesting video provided by the company X.

The revenue generated by the content provider is far less than the money spent on creating the streaming videos, thereby making the business of creating interesting videos (which may have higher probability of getting a great number of views). In addition, the advertisements inserted between the videos are less effective than brand marketing content videos. These brand marketing content videos benefits the advertisers as well as brand marketing content providers. However, every now and then, the advertisers do not find effective brand marketing content providers who can provide them branded marketing content as per needs. In addition, sometimes the branded marketing content providers do not find appropriate advertisers where they can connect with the advertisers.

In light of the above discussion, there is a need for a method and system which overcomes all the above stated problems.

### SUMMARY OF THE DISCLOSURE

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

In an aspect of the present disclosure, a system for managing an online marketplace platform for branded marketing content is provided. The system includes a receiving module configured to receive one or more of branded marketing content by a plurality of branded marketing content providers, a displaying module configured to display a set of one or more of branded marketing content by a respective set of the plurality of branded marketing content providers and a contracting module. Each of the one or more branded marketing content includes one or more videos. The one or more of branded marketing content is requested by an advertiser. The branded marketing content is received by the receiving module by configuring a branded content management application. The displaying module enables selection of the set of one or more of branded marketing content to present to the advertiser. The displaying modules enables input and receiving selection of the one or more of branded marketing content by one or more managed service providers and the advertiser. The contracting module enables contracting a deal between the first of one or more of branded content providers with the advertiser. The advertiser and the one or more of branded content providers strikes a deal on meeting of pre-defined conditions. The advertiser may request based on a predefined criteria and a pre-defined one or more formats. The branded marketing content providers may provide one or more sample sales pitch in a pre-defined digital sample formats in response to branded marketing content being requested.

In an embodiment of the present disclosure, the receiving module is further configured to receive real time request generated by a plurality of advertisers. Each of the plurality of advertisers selects a first respective one or more branded marketing content and strikes a deal between the respective selected first respective one or more branded marketing content.

In an embodiment of the present disclosure, the system further includes configuring a selection application in association with the advertiser to present the advertiser with a standard network request for accessing the branded marketing content.

In an embodiment of the present disclosure, a community management application in association with one or manage service providers enables receiving, analysing and displaying the branded marketing content with respect to the advertiser.

In an embodiment of the present disclosure, the contracting module further includes providing an appropriate compensation with respect to the one or more branded marketing content based on a reward provided by the advertiser in the social network.

In an embodiment of the present disclosure, the contracting module further comprises an automated enforcement module to prevent the one or more branded marketing content providers from uploading similar templates in the branded marketing content marketplace while protecting one or template associated with a respective the one or more branded marketing service providers.

In an embodiment of the present disclosure, the system further includes a feedback module configured to provide an instant feedback report with respect to uniqueness of a template uploaded by a content provider in the online branded marketing marketplace.

In an embodiment of the present disclosure, the displaying module is configured to display a hot trend scenario and a rank with respect to a branded marketing content of the one or more of branded marketing content at a dashboard.

In an embodiment of the present disclosure, the system includes configuring at least one reward to comprise at least one of the following types of rewards: an initial user rating; and ongoing popularity with respect to each of one or more of branded marketing content being requested by the advertiser.

In another aspect of the present disclosure, a computer system for managing an online marketplace platform for branded marketing content is provided. The computer system includes one or more processors and a non-transitory memory containing instructions that, when executed by the one or more processors, causes the one or more processors to perform a set of steps. The set of steps includes receiving one or more of branded marketing content by a plurality of branded marketing content providers by a receiving module. Each of the one or more branded marketing content including one or more videos. The one or more of branded marketing content is requested by an advertiser. The branded marketing content is received by the receiving module by configuring a branded content management application. The set of steps further includes displaying a set of one or more of branded marketing content by a respective set of the plurality of branded marketing content providers, by a displaying module. The displaying module enables selection of the set of one or more of branded marketing content to present to the advertiser. The displaying modules enables input and receiving selection of the one or more of branded marketing content by one or more managed service providers and the advertiser. The set of steps further includes contracting a deal between the first of one or more of branded content providers with the advertiser by a contracting module. The advertiser and the one or more of branded content providers strikes a deal on meeting of pre-defined conditions. The advertiser may request based on a predefined criteria and a pre-defined one or more formats. The branded marketing content providers may provide one or more sample sales pitch in a pre-defined digital sample formats in response to branded marketing content being requested.

In an embodiment of the present disclosure, the one or more processors are further configured to receive real time request generated by a plurality of advertisers. Each of the plurality of advertisers selects a first respective one or more branded marketing content and strikes a deal between the respective selected first respective one or more branded marketing content.

In an embodiment of the present disclosure, the one or more processors includes configuring a selection application in association with the advertiser to present the advertiser with a standard network request for accessing the branded marketing content.

In an embodiment of the present disclosure, one or more processors enable a community management application in association with one or manage service providers to receive, analyse and display the branded marketing content with respect to the advertiser.

In an embodiment of the present disclosure, one or more processors further includes provides an appropriate compensation with respect to the one or more branded marketing content based on a reward provided by the advertiser in the social network.

In an embodiment of the present disclosure, one or more processors further comprises an automated enforcement module to prevent the one or more branded marketing content providers from uploading similar templates in the branded marketing content marketplace while protecting one or template associated with a respective the one or more branded marketing service providers.

In an embodiment of the present disclosure, the one or more processors further includes a feedback module configured to provide an instant feedback report with respect to uniqueness of a template uploaded by a content provider in the online branded marketing marketplace.

In an embodiment of the present disclosure, the one or more processors enables the displaying module to display a hot trend scenario and a rank with respect to a branded marketing content of the one or more of branded marketing content at a dashboard.

In an embodiment of the present disclosure, the one or more processors includes configuring at least one reward to comprise at least one of the following types of rewards: an initial user rating; and on-going popularity with respect to each of one or more of branded marketing content being requested by the advertiser.

In yet another aspect of the present disclosure, a method for managing an online marketplace platform for branded marketing content is provided. The method includes receiving one or more of branded marketing content by a plurality of branded marketing content providers, displaying a set of one or more of branded marketing content by a respective set of the plurality of branded marketing content providers and contracting a deal between the first of one or more of branded content providers with the advertiser. Each of the one or more branded marketing content includes one or more videos. The one or more of branded marketing content is requested by an advertiser. The branded marketing content is received by a receiving module by configuring a branded content management application. A displaying module enables selection of the set of one or more of branded marketing content to present to the advertiser. The displaying modules enables input and receiving selection of the one or more of branded marketing content by one or more managed service providers and the advertiser. The advertiser and the one or more of branded content providers strikes a deal on meeting of pre-defined conditions. The advertiser may request based on a predefined criteria and a pre-defined one or more formats. The branded marketing content providers may provide one or more sample sales pitch in a pre-defined digital sample formats in response to branded marketing content being requested.

In an embodiment of the present disclosure, the method further includes preventing the one or more branded marketing content providers from uploading similar templates in the branded marketing content marketplace while protecting one or template associated with a respective the one or more branded marketing service providers.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates a block diagram of a computer system 100 for enabling various embodiments of the present disclosure;

FIG. 2 and FIG. 3 illustrates a system for enabling managing of an online marketplace platform for branded marketing content, in accordance with various embodiments of the present disclosure;

FIG. 4 illustrates a block diagram of an online marketplace platform, in accordance with various embodiments of the present disclosure; and

FIG. 5 illustrates a method for enabling managing of the online marketplace platform for branded marketing content, in accordance with various embodiments of the present disclosure

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

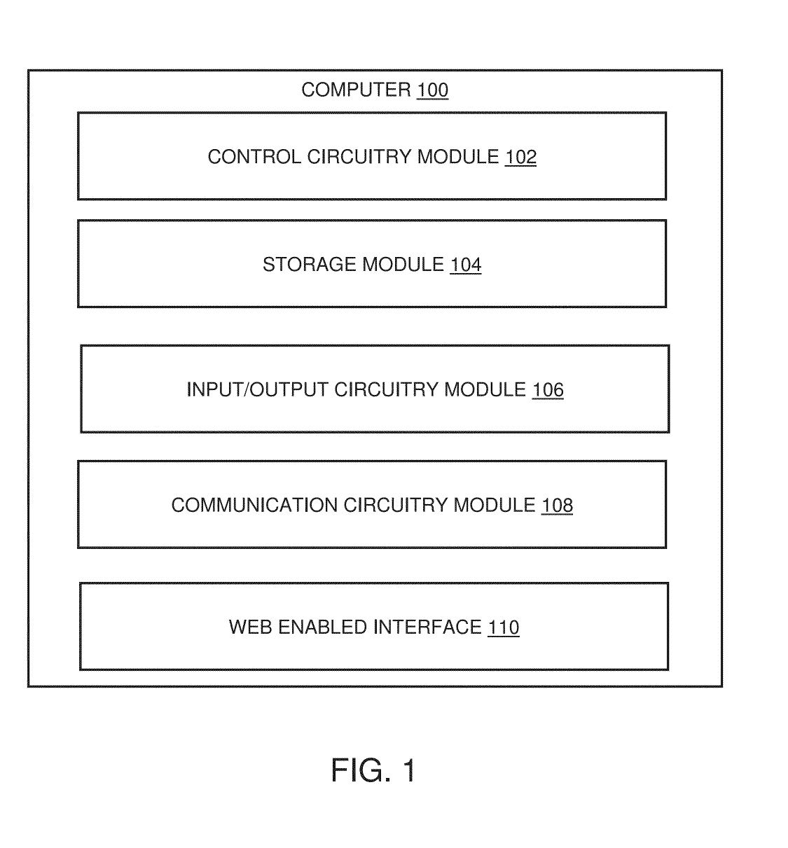

FIG. 1 illustrates a block diagram of a computer system 100 for enabling various embodiments of the present disclosure. The computer system 100 (or computer 100) includes a control circuitry module 102, a storage module 104, an input/output circuitry module 106, a communication circuitry module 108 and a web-enabled interface 110. The computer 100 includes any suitable type of portable electronic device. Examples of the computer 100 include but may not be limited to a personal e-mail device (e.g., a Blackberry.TM. made available by Research in Motion of Waterloo, Ontario), a personal data assistant (“PDA”), a cellular telephone, a Smartphone, a handheld gaming device, a digital camera, a laptop computer, and a tablet computer. In another embodiment of the present disclosure, the computer 100 can be a desktop computer.

From the perspective of this disclosure, the control circuitry module 102 includes any processing circuitry or processor operative to control the operations and performance of the computer 100. For example, the control circuitry module 102 may be used to run operating system applications, firmware applications, media playback applications, media editing applications, or any other application. In an embodiment, the control circuitry module 102 drives a display and process inputs received from a user interface.

From the perspective of this disclosure, the storage module 104 includes one or more storage mediums including a hard-drive, solid state drive, flash memory, permanent memory such as ROM, any other suitable type of storage component, or any combination thereof. The storage module 104 may store, for example, media data (e.g., music and video files), application data (e.g., for implementing functions on the computer 100).

From the perspective of this disclosure, the I/O circuitry module 106 may be operative to convert (and encode/decode, if necessary) analog signals and other signals into digital data. In an embodiment, the I/O circuitry module 106 may also convert digital data into any other type of signal, and vice-versa. For example, the I/O circuitry module 106 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 102, the storage module 104, or any other component of the computer 100.

It may be noted that the I/O circuitry module 106 is illustrated in FIG. 1 as a single component of the computer 100; however those skilled in the art would appreciate that several instances of the I/O circuitry module 106 may be included in the computer 100.

The computer 100 may include any suitable interface or component for allowing a user to provide inputs to the I/O circuitry module 106. The computer 100 may include any suitable input mechanism. Examples of the input mechanism include but may not be limited to a button, keypad, dial, a click wheel, and a touch screen. In an embodiment, the computer 100 may include a capacitive sensing mechanism, or a multi-touch capacitive sensing mechanism.

In an embodiment, the computer 100 may include specialized output circuitry associated with output devices such as, for example, one or more audio outputs. The audio output may include one or more speakers built into the computer 100, or an audio component that may be remotely coupled to the computer 100.

The one or more speakers can be mono speakers, stereo speakers, or a combination of both. The audio component can be a headset, headphones or ear buds that may be coupled to communications device with a wire or wirelessly.

In an embodiment, the I/O circuitry module 106 may include display circuitry for providing a display visible to the user. For example, the display circuitry may include a screen (e.g., an LCD screen) that is incorporated in the computer 100.

The display circuitry may include a movable display or a projecting system for providing a display of content on a surface remote from the computer 100 (e.g., a video projector). In an embodiment, the display circuitry may include a coder/decoder to convert digital media data into analog signals. For example, the display circuitry may include video Codecs, audio Codecs, or any other suitable type of Codec.

The display circuitry may include display driver circuitry, circuitry for driving display drivers, or both. The display circuitry may be operative to display content. The display content can include media playback information, application screens for applications implemented on the electronic device, information regarding on-going communications operations, information regarding incoming communications requests, or device operation screens under the direction of the control circuitry module 102. Alternatively, the display circuitry may be operative to provide instructions to a remote display.

In addition, the computer 100 includes the communications circuitry module 108. The communications circuitry module 108 may include any suitable communications circuitry operative to connect to a communications network and to transmit communications (e.g., voice or data) from the computer 100 to other devices within the communications network. The communications circuitry 108may be operative to interface with the communications network using any suitable communications protocol. Examples of the communications protocol include but may not be limited to Wi-Fi, Bluetooth.RTM, radio frequency systems, infrared, LTE, GSM, GSM plus EDGE, CDMA, and quadband.

In an embodiment, the communications circuitry module 108 may be operative to create a communications network using any suitable communications protocol. For example, the communications circuitry module 108 may create a short-range communications network using a short-range communications protocol to connect to other devices. For example, the communications circuitry module 108 may be operative to create a local communications network using the Bluetooth, RTM protocol to couple the computer 100 with a Bluetooth, RTM headset.

The web-enabled interface 110 enables one or more application programs, such as software application, to be “loaded” for execution by the computer system 100. The computer system 100 receives user commands and data through user interface; these inputs may then be acted upon by the computer system 100 in accordance with instructions from an operating system module and/or software application.

It may be noted that the above discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” constitutes a software application. Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

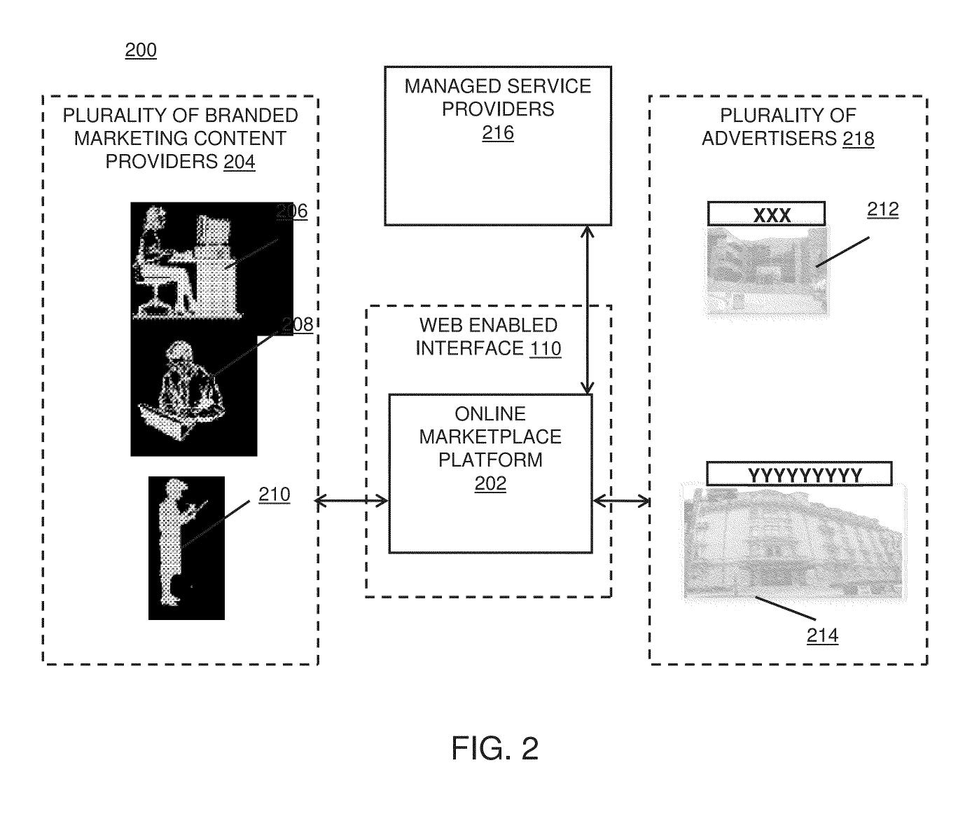

FIG. 2 illustrates a system 200 for enabling managing of an online marketplace platform 202 for branded marketing content in accordance with various embodiments of the present disclosure. Branded marketing content is a marketing technique of creating and distributing valuable, relevant and consistent content. The branded marketing content attracts and acquires a clearly defined audience with the objective of driving profitable customer action. The branded marketing content is an ongoing process that is integrated into overall marketing strategy, and focuses on owning media, not renting it. In addition, the branded marketing content is the art of communicating with the customers and prospects without selling. It is a form of non-interruption marketing.

The system 200 includes a plurality of branded marketing content providers 204 (say a branded marketing content provider 206, a branded marketing content provider 208 and a branded marketing content provider 210). These branded marketing content providers 204 may provide the branded marketing content on the online market place platform 202. Each of the branded marketing content provider 206, the branded marketing content provider 208 and the branded marketing content provider 210 can be architects, graphic artists, designers, programmers, quality assurance engineers, or others with domain experience applicable to the video templates. The branded marketing content providers 204 may provide the branded marketing content video on the online market place platform 202 based on request generated by the advertiser 212.

In an embodiment of the present disclosure, these branded marketing content providers 204 may provide the branded marketing content to an advertiser (say an advertiser 212 or an advertiser 214) of the plurality of advertisers 218. The advertiser 212 (or the advertiser 214) may select the content of one or more branded marketing content providers 204 by analysing the branded marketing content on their own on the online marketplace platform or by utilizing the services of one or manage service providers 216. In an embodiment of the present disclosure, the selection may be based on pre-defined criterions set by the advertiser 212 and/or by the one or more managed service providers 216.

In an embodiment of the present disclosure, any of the plurality of advertisers 218 (say an advertiser 212 or an advertiser 214) may ask for a sales pitch for a pre-defined episodes for promoting a particular product/product category to reach a pre-defined audience. For example, a company X may like to do a twenty episode web series. The company X may want to do it in the vein of sports and comedy. The company X may have the target audience of men having age ranging 18 to 49. The online market place platform 202 may enable providing the request for sales pitch in a pre-defined format and a pre-defined set of conditions/criteria. Accordingly, the branded marketing content providers 204 (say the branded marketing content provider 206, the branded marketing content provider 208 and the branded marketing content provider 210) may put together pitch decks. The pitch decks may be in different formats which include but may not be limited to a one page pitch, a power point presentation, a sizzle (say a short 30 second to one minute video), a fully realized and completed series, and the like. The advertiser 212 may pick amongst these on the online marketplace 202 and select a best fit on the online marketplace 202. In an embodiment of the present disclosure, the owner of the web-enabled interface 110 may ask the advertiser 212 or selected branded market content provider 206 to pay a commission. In the above stated example, the company X may buy the concept and the owner of the web-enabled interface 110 pay a fee on that transaction.

In the above stated example, there may also be a larger deal where the web-enabled interface 110 may allow for the execution of the creation of the actual digital series. A one page sales sheet may allow for the development of10 scripts: one for each of the episodes, storyboards, and the like. The one page sales sheet may meaning a visual of how the actual 10 episodes will look, and ideas for integration meaning how the product of the advertiser 212 may actually be integrated into the story of the ten episodes, and execution of the process. In an embodiment of the present disclosure, a recommendation to advertisers may be provided by an administrator to the web-enabled interface 110. One such recommendation is to skip the first episode so that the whole episode should not sound like a commercial. In an embodiment of the present disclosure, the web-enabled interface 110 may allow for editing as well and suggestions for same by allowing the digital studio to upload the video and have the advertiser 212 make comments or revisions through the web-enabled interface 110.

In an embodiment of the present disclosure, the web-enabled interface 110 may be a place for shopping and discovery of concepts. For example, the advertiser 212 may not know the exact requirements. For example, an advertiser (company Y) may want to target women. The company Y may go on to a part of the web-enabled interface 110 which has preloaded projects directed towards women. In this space, the company Y may shop for digital properties to which it might want to integrate into. These projects may largely be ones that have not been released in the marketplace. It may avoid the concern for the digital studio idea to be out in the market.

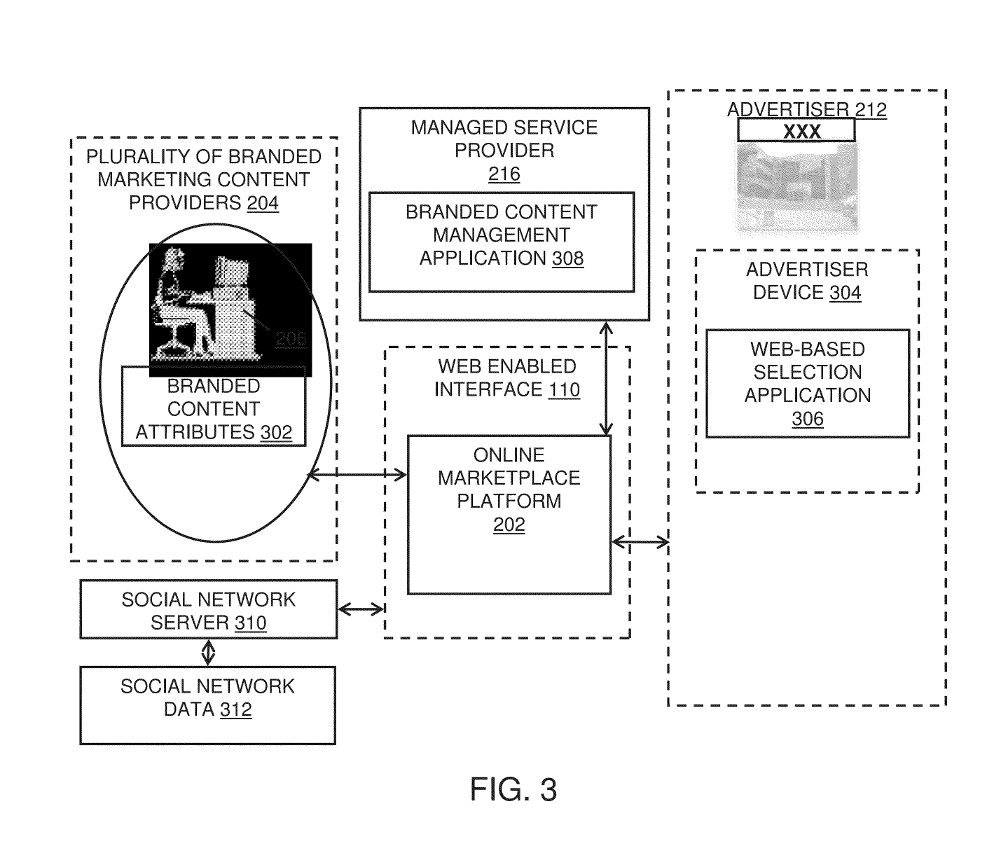

In an embodiment of the present disclosure, referring to FIG. 3, a branded content management application 308 is installed on the devices of one or managed service providers 216. A service provider server for one or managed service providers 216 includes an evaluation algorithm for analysing, receiving and evaluating a branded marketing content (having branded marketing content video) with respect to the branded marketing content providers 204 in the branded content management application 308. In an embodiment of the present disclosure, the service provider server can be an e-commerce system, depending upon the design considerations. A social network server 310 can include a database for storing the social network user data 312. Such data 312 is accessed by the service provider server and the advertiser 212 pertaining to the branded marketing content video, and can be stored into a user database of the service provider server.

In an embodiment of the present disclosure, the branded content management application 308 adapts an automated enforcement process in order to prevent uploading similar/existing branded marketing content video. It may be noted that the automated enforcement application may be implemented according to the technology presently known in the art which may utilize the branded content attributes 302 of the branded marketing content video.

In an embodiment of the present disclosure, a web based selection application 306 is configured in association with the advertiser 212 in order to present the advertiser 212 with a standard network request for accessing the branded marketing content video. The advertiser 212 is routed to an interface upon obtaining the permission in order to select the branded marketing content video from a series of categories. The customer profile can be extracted from the social network database in order to populate the user database of the managed service providers 216.

The web based selection application 306 displays a toolbar, a product catalogue, and an order review with respect to the branded marketing content video. The managed service provider server includes a dash board for providing hot trend scenarios and ranks with respect to the branded marketing content video. Once, the advertiser 212 selects the branded marketing content video is selected by the advertiser 212, a contract is signed by the branded marketing content provider 206 with the advertiser 212 by utilizing an interface on the online marketplace platform 202. The contract is signed by meeting on satisfying the plurality of pre-defined criterion being agreed by both the branded marketing content provider 206 and the advertiser 212. In an embodiment, the interface may provide a list of editable criterion on the online marketing place 202. The list of editable criterion on the online marketing place 202 may work on the collaborative mode till striking a deal between the advertiser 212 and the branded marketing content provider 206. In an embodiment of the present disclosure, once the deal is stuck with respect to the branded marketing video content, the advertiser 212 may post the branded marketing video content on different platforms to earn revenue or market his/her brand.

In an embodiment of the present disclosure, the compensation/payment is periodically provided based on the percentage of profit, popularity and creativity of the branded marketing content provider (say branded marketing content provider 206) as judged by the advertiser 212. The payment/compensation may be provided to the branded marketing content provider 206. In an embodiment of the present disclosure, the service provider server also provides a personalized report and payment/reward with respect to the branded marketing content provider 206.

In an embodiment of the present disclosure, branded marketing content provider 206 submits the user information such as, tax information, payment preferences and other identity information in order to register with the service provider server.

In an embodiment of the present disclosure, a graphical user interface representing an order review option to respective plurality of branded content providers 204 is provided. In an embodiment of the present disclosure, a graphical user interface representing an order review option to respective plurality of advertisers 218 is provided.

In another embodiment of the present disclosure, the branded marketing content provider (say branded marketing content provider 206) uses the online marketplace platform portal to submit a proposal for creating the branded content for the advertiser 212. In an initial action, the branded marketing content provider 206 makes a freelance pitch on the online marketplace platform 202 and declares it available for purchase and/or counterproposal. The online marketplace platform 202stores the pitch for a predetermined period. The advertiser 212 indicates interest in a pitch by either purchasing it or submitting a counterproposal, which would include new suggested terms for the pitch. If the branded marketing content provider 206 accepts the advertiser 212 counterproposal, the online marketplace platform 202 reclassifies the pitch as an active project.

Once the pitch becomes an active project, the branded marketing content provider 206 and advertiser 212 can use the online marketplace platform 202 to manage the project's progress from pitch to finished work. In one embodiment, the branded marketing content provider 206 completes a first draft of the work. In the next action, the advertiser 212 reviews the draft and either submits it back to the branded marketing content provider 206 for redraft, accept the work, or kill the project. If the advertiser 212 chooses to kill the project, the advertiser 212 still be obligated to pay the branded marketing content provider 206 the pre-negotiated “kill fee,” if any exists.

Once the advertiser 212 accepts a final draft, the advertiser 212 conducts a final review, and confirms purchase of the branded marketing content provider 206 under the previously negotiated terms and conditions. The process ends with the online marketplace platform 202 delivering the purchased work.

In the process, the advertiser 212 can use the online marketplace platform portal 202 to create assignments and either assign them to specific the branded marketing content provider 206, or make them available to a pool of the branded marketing content provider 206 for selection. In one embodiment, the process begins by an advertiser 212 submitting an assignment. The online marketplace platform 202 content platform stores the assignment for a predetermined review period. The branded marketing content provider 206 has the option of selecting the assignment, rejecting it, or submitting a counterproposal. In a further embodiment, the advertiser 212 can generate a list of two or more the branded marketing content providers, ranked in order of preference. In another embodiment, the advertiser 212 will be able to search, sort, and rank a list of the branded marketing content providers 204 by a multiple of factors, including reputation, suggested compensation, and areas of expertise. The online marketplace platform 202 initiate a sub-process to grant the highest ranked the branded marketing content provider 206 a period of time to review and accept the assignment; if the assignment is not accepted, the online marketplace platform 202 then allow the next highest-ranked the branded marketing content provider an interval of time to review and accept the assignment.

If no the branded marketing content provider 206 expresses interest in the assignment within the review period, then the online marketplace platform 202 designates the assignment as expired.

If the branded marketing content provider 206 accepts the assignment, then the online marketplace platform 202 designates the assignment to be an active project, and the process can continue as explained. If the branded marketing content provider 206 offers a counterproposal, then the advertiser 212 can either accept the branded marketing content provider 206's proposed terms and initiate an active project, provide a counter to the branded marketing content provider 206≦s counterproposal, or resubmit the assignment to another the branded marketing content provider 206 for selection. In one embodiment, the advertiser 212 can authorize the online marketplace platform 202 to restart sub-process and submit the assignment to the next highest-ranked the branded marketing content provider for selection. The process ends either with an accepted proposal, which is then reclassified as an active project, or with the expiration of the predetermined time frame, at which point the assignment is classified as expired.

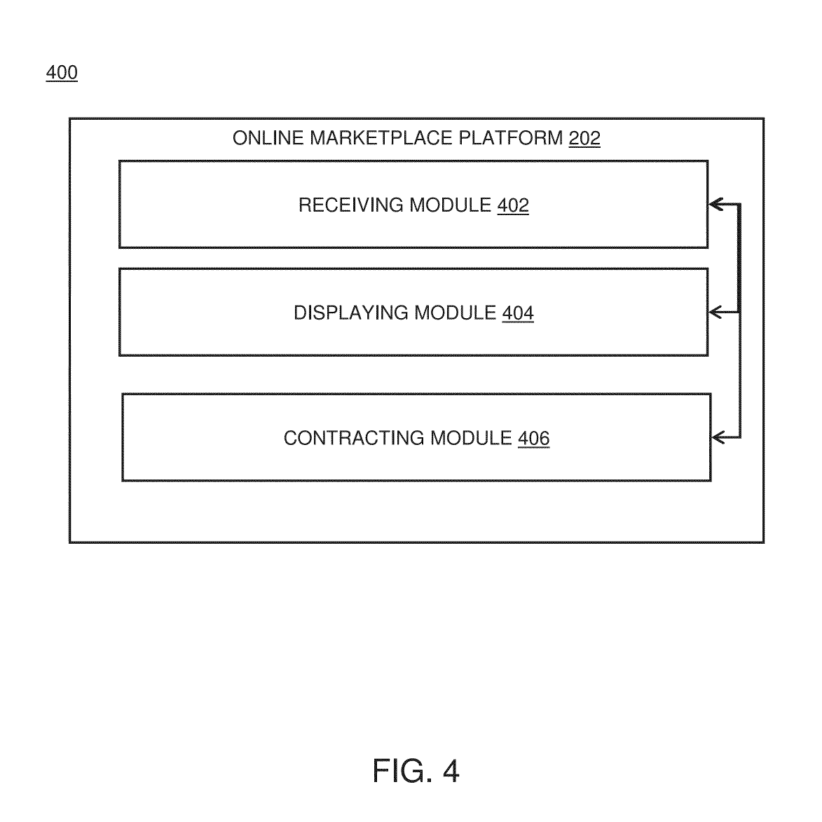

In an embodiment of the present disclosure, referring to a block diagram 400 shown in FIG. 4, the online marketplace platform 202 includes a receiving module 402, a displaying module 404 and a contracting module 406. It may be noted that there can be different modules associated with the online marketplace platform 202 which may enable the stated embodiments of the present disclosure. The receiving module 402 receives one or more of branded marketing content by the plurality of branded marketing content providers 204. The displaying module 404 displays a set of one or more of branded marketing content by a respective set of the plurality of branded marketing content providers 204. Each of the one or more branded marketing content includes one or more videos. The one or more of branded marketing content is requested by the advertiser 212. The branded marketing content is received by the receiving module 402 by configuring the branded content management application 308. The displaying module 404 enables selection of the set of one or more of branded marketing content to present to the advertiser 212. The displaying module 404 enables input and receiving selection of the one or more of branded marketing content by one or more managed service providers 216 and the advertiser 212. The contracting module 406 enables contracting a deal between the first of one or more of branded content providers 204 with the advertiser 212. The advertiser 212 and the one or more of branded content providers 204 strikes a deal on meeting of pre-defined conditions.

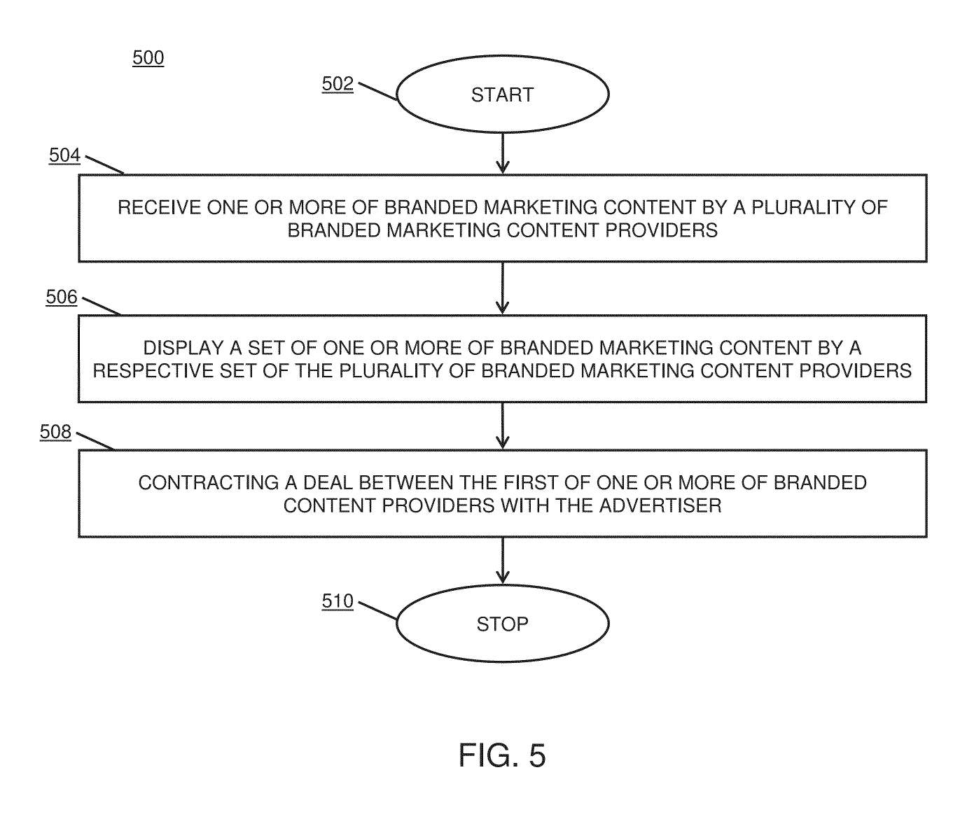

FIG. 5 illustrates a flow chart 500 for managing the online marketplace platform 202 for branded marketing content, in accordance with various embodiments of the present disclosure. The flow chart initiates at step 502. At step 504, as explained above, the receiving module 402 receives one or more of branded marketing content by a plurality of branded marketing content providers 204. The one or more of branded marketing content is requested by the advertiser 212. The branded marketing content is received by the receiving module 402 by configuring the branded content management application 308.

At step 506, as elaborated above, the displaying module 404 displays a set of one or more of branded marketing content by a respective set of the plurality of branded marketing content providers 204. The displaying module 404 enables selection of the set of one or more of branded marketing content to present to the advertiser 212. The displaying module 404 enables input and receiving selection of the one or more of branded marketing content by one or more managed service providers 216 and the advertiser 212.

At step 508, as explained above, the contracting module 406 contracts a deal between the first of one or more of branded content providers 204 with the advertiser 212. The advertiser 212 and the one or more of branded content providers 204 strikes a deal on meeting of pre-defined conditions. The flow chart terminates at step 510.

While several possible embodiments of the disclosure have been described above and illustrated in some cases, it should be interpreted and understood as to have been presented only by way of illustration and example, but not by limitation. Thus, the breadth and scope of a preferred embodiment should not be limited by any of the above-described exemplary embodiments.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A system for managing an online marketplace platform for branded marketing content, the system comprising:
a receiving module configured to receive one or more of branded marketing content by a plurality of branded marketing content providers, wherein each of said one or more branded marketing content including one or more videos, wherein said one or more of branded marketing content being requested by an advertiser based on a predefined criteria and a pre-defined one or more formats and wherein branded marketing content being received by said receiving module by configuring a branded content management application;
a displaying module configured to display
a set of one or more of branded marketing content by a respective set of said plurality of branded marketing content providers;
one or more sample sales pitch in a pre-defined digital sample formats made by one or more branded marketing content providers in response to branded marketing content being requested; and
wherein said displaying module enables selection of said set of one or more of branded marketing content to present to said advertiser, wherein said displaying modules enables input and receiving selection of said one or more of branded marketing content by one or more managed service providers and said advertiser;
a contracting module, wherein said contracting modules enables contracting a deal between said first of one or more of branded content providers with said advertiser, wherein said advertiser and said one or more of branded content providers strikes a deal on meeting of a pre-defined conditions.

2. The system as recited in claim 1, wherein said receiving module further configured receiving real time request generated by a plurality of advertisers, wherein each of said plurality of advertisers selects a first respective one or more branded marketing content and strikes a deal between said respective selected first respective one or more branded marketing content.

3. The system as recited in claim 1, further comprising configuring a selection application in association with said advertiser to present said advertiser with a standard network request for accessing said branded marketing content.

4. The system as recited in claim 1, wherein a community management application in association with said one or manage service providers enables receiving, analysing and displaying said branded marketing content with respect to said advertiser.

5. The system as recited in claim 1, wherein said contracting module further comprises providing an appropriate compensation with respect to said one or more branded marketing content based on a reward provided by said advertiser in said social network.

6. The system as recited in claim 5, wherein said contracting module further comprises an automated enforcement module to prevent said one or more branded marketing content providers from uploading similar templates in said branded marketing content marketplace while protecting one or template associated with a respective said one or more branded marketing service providers.

7. The system as recited in claim 1, further comprising a feedback module configured to provide an instant feedback report with respect to uniqueness of a template uploaded by a content provider in said online branded marketing marketplace.

8. The system as recited in claim 1, wherein said displaying module is configured to display a hot trend scenario and a rank with respect to a branded marketing content of said one or more of branded marketing content at a dashboard.

9. The system as recited in claim 1, further comprising configuring at least one reward to comprise at least one of the following types of rewards: an initial user rating; and ongoing popularity with respect to each of one or more of branded marketing content being requested by said advertiser.

10. A computer system for managing an online marketplace platform for branded marketing content, the system comprising:
one or more processors; and
a non-transitory memory containing instructions that, when executed by said one or more processors, causes said one or more processors to perform a set of steps comprising:
receiving, by a receiving module, one or more of branded marketing content by a plurality of branded marketing content providers, wherein each of said one or more branded marketing content including one or more videos, wherein said one or more of branded marketing content being requested by an advertiser based on a predefined criteria and a pre-defined one or more formats and wherein branded marketing content being received by said receiving module by configuring a branded content management application;
displaying, by a displaying module, a set of one or more of branded marketing content by a respective set of said plurality of branded marketing content providers and one or more sample sales pitch in a pre-defined digital sample formats made by one or more branded marketing content providers in response to branded marketing content being requested; and
wherein said displaying module enables selection of said set of one or more of branded marketing content to present to said advertiser, wherein said displaying modules enables input and receiving selection of said one or more of branded marketing content by one or more managed service providers and said advertiser; and
contracting, by a contracting module, a deal between said first of one or more of branded content providers with said advertiser, wherein said advertiser and said one or more of branded content providers strikes a deal on meeting of a pre-defined conditions.

11. The computer system as recited in claim 10, wherein said one or more processors further receives, by said receiving module, real time request generated by a plurality of advertisers, wherein each of said plurality of advertisers selects a first respective one or more branded marketing content and strikes a deal between said respective selected first respective one or more branded marketing content.

12. The computer system as recited in claim 10, wherein said one or more processors enables a selection application in association with said advertiser to present said advertiser with a standard network request for accessing said branded marketing content.

13. The computer system as recited in claim 10, wherein said one or more processors enables a community management application in association with said one or manage service providers to receiving, analysing and displaying said branded marketing content with respect to said advertiser.

14. The computer system as recited in claim 10, wherein said one or more processors further enables to provide, by said contracting module, an appropriate compensation with respect to said one or more branded marketing content based on a reward provided by said advertiser in said social network.

15. The computer system as recited in claim 10, wherein said one or more processors further enables an automated enforcement module to prevent said one or more branded marketing content providers from uploading similar templates in said branded marketing content marketplace while protecting one or template associated with a respective said one or more branded marketing service providers.

16. The computer system as recited in claim 10, wherein said one or more processors further enables a feedback module to provide an instant feedback report with respect to uniqueness of a template uploaded by a content provider in said online branded marketing marketplace.

17. The computer system as recited in claim 10, wherein said one or more processors enables said displaying module to display a hot trend scenario and a rank with respect to a branded marketing content of said one or more of branded marketing content at a dashboard.

18. The computer system as recited in claim 10, wherein said one or more processors further enables configuring at least one reward to comprise at least one of the following types of rewards: an initial user rating; and ongoing popularity with respect to each of one or more of branded marketing content being requested by said advertiser.

19. A method for managing an online marketplace platform for branded marketing content, the method comprising:
receiving one or more of branded marketing content by a plurality of branded marketing content providers, wherein each of said one or more branded marketing content including one or more videos, wherein said one or more of branded marketing content being requested by an advertiser based on a predefined criteria and a pre-defined one or more formats and wherein branded marketing content being received by a receiving module by configuring a branded content management application;
displaying a set of one or more of branded marketing content by a respective set of said plurality of branded marketing content providers by and one or more sample sales pitch in a pre-defined digital sample formats made by one or more branded marketing content providers in response to branded marketing content being requested; and
wherein a displaying module enables selection of said set of one or more of branded marketing content to present to said advertiser, wherein said displaying modules enables input and receiving selection of said one or more of branded marketing content by one or more managed service providers and said advertiser; and
contracting a deal between said first of one or more of branded content providers with said advertiser, wherein said advertiser and said one or more of branded content providers' strikes a deal on meeting of a pre-defined conditions.

20. The method as recited in claim 19, further comprising preventing said one or more branded marketing content providers from uploading similar templates in said branded marketing content marketplace while protecting one or template associated with a respective said one or more branded marketing service providers.
